(19) United States
(12) Patent Application Publication
(10) Pub. No.: US 2005/0256590 A1
(43) Pub. Date: Nov. 17, 2005

(54) Remote controller data download system using a internet and its method

(76) Inventor: Hyung Rack Choi, Bucheon-shi (KR)

Correspondence Address: STAAS & HALSEY LLP, SUITE 700, 1201 NEW YORK AVENUE, N.W., WASHINGTON, DC, 20005, US

(21) Appl. No.: 10/500,004

(22) PCT Filed: Dec. 24, 2002
(86) PCT No.: PCT/KR02/02428

§ 371 Date: Jun. 6, 2005

(30) Foreign Application Priority Data
Dec. 24, 2001 (KR) 10-2001-0084255

(51) Int. Cl. G05B 11/01

(52) U.S. Cl. 700/20

(57) ABSTRACT

The present invention relates to a system and method for downloading remote control data using the Internet. In the system and method, a server unit is provided with remote control data, a user selects required remote control data through a client personal computer and a remote control code transmitting system, and the selected data is transmitted to a remote controller in a wired or wireless manner. In accordance with the present invention, the user can appropriately utilize a single remote controller for various apparatuses.

### TECHNICAL FIELD

The present invention relates to a system and method for downloading remote control data for various apparatuses to a remote controller using the Internet so as to allow a single remote controller to be used to remotely control the various apparatuses.

### BACKGROUND ART

In general, remote controllers that are a kind of wireless control device are used to improve the convenience of end users who use apparatuses to be remotely controlled. The remote controllers are widely used to wirelessly control home appliances, office machines, etc. at places somewhat remote from the apparatuses. Recently, with the development of the electronics industry and semiconductor manufacturing technology, research and development have been performed to provide remote controllers having broader and more various functions.

However, since in a conventional remote control device and method, a remote controller is provided for each of apparatuses and the apparatus is controlled by only the corresponding remote controller, a new remote controller should be purchased or a user should manually manipulate the keys of the apparatus when the remote controller is lost or breaks down.

In order to overcome the conventional remote control device and method, there was proposed a so-called integrated remote controller in which control data for various apparatuses are set and which allows various apparatuses to be remotely controlled therethrough.

However, the second remote control device is problematic in that general users cannot use the second remote control device because a control data setting method is complicated.

### DISCLOSURE OF THE INVENTION

Accordingly, the present invention is proposed to solve the above problems occurring in the prior art, and an object of the present invention is to provide a system and method for downloading remote control data using the Internet, which is capable of accessing a server having remote control data for various apparatuses via the Internet, downloading required data from the servers to a remote controller in a wired or wireless manner and setting the downloaded data in the remote controller.

In order to accomplish the above object, the present invention provides a system for downloading remote control data using the Internet, including a server unit (10) having remote control data; a client Personal Computer (PC) (30) processing the remote control data; a remote control code transmitting system (40); the Internet (20) connecting the server unit (10), the client PC (30) and the remote control code transmitting system (40) to each other; and two remote controllers (50 and 50′) connected to the system in wired and wireless manners, respectively; wherein the server unit (10) includes a database server (11) having the remote control data for apparatuses to be remotely controlled and performing responses and data transmission with respect to various requests, an authentication system (12) connected to the database server (11) to perform user authentication, and a billing settlement system (13) connected to the database server (11) to update billing information of users; wherein the client PC (30) includes a first interface unit (31) requesting the server unit (10) to transmit the remote control data through the Internet 20 and receiving transmitted remote control data, a temporary storage space (32) temporarily storing the received remote controller data, a data analysis unit (33) determining a transmission method of the remote control data, and a second interface unit (34) transmitting the remote control data in a wired manner; wherein the remote control code transmitting system (40) includes a third interface unit (41) receiving transmitted remote control data through the first interface unit (31), a temporary storage space (42) temporarily storing the received data, and a fourth interface unit (43) transmitting the stored remote control data to the remote controller (50′) in a wireless manner; wherein the remote controllers (50 and 50′) each include a terminal (51) connected to the client PC (30) in a wired manner to receive the remote control data, or transceiver unit (54) receiving the remote control data from the remote control code transmitting system (40) in a wireless manner, a control unit (52) converting the transmitted data into data in a required manner, and a storage unit (53) storing the data converted by the control unit (52).

In order to accomplish the above object, the present invention provides a method for downloading remote control data using the Internet, including the Ist step of a client PC (30) requesting remote control data, which is selected by a user to download, from a server unit (10) through a first interface unit (31); the 2nd step of the client PC (30) undergoing user authentication in the server unit (10); the 3rd step of the client PC (30) receiving remote control data transmitted from the server unit (10) in response to the request through the first interface unit (31); the 4th step of the client PC (30) temporarily storing the received remote control data in the temporary storage space (32); the 5TH step of the client PC (30) determining whether the remote control data is transmitted in a wired or wireless manner through the use of a data analysis unit (33); the 6th step of the client PC (30) transmitting the remote control data to a terminal (51) of the remote controller (50) through a second interface unit (34) if it is determined that the data is transmitted in a wired manner; the 7th step of the remote controller (50) receiving the remote control data from the terminal (51); the 8th step of the remote controller (50) converting the remote control data into data in a required manner; and the 9th step of the remote controller (50) storing the converted remote control data in a storage unit (53).

### BRIEF DESCRIPTION OF THE DRAWINGS

FIG. 1 is a view schematically showing the construction of a system for downing remote control data using the Internet in accordance with the embodiment of the present invention;

FIG. 2 is a view showing the construction of a server unit in accordance with the embodiment of the present invention;

FIG. 3 is a view showing the construction of a remote control data processing unit in accordance with the embodiment of the present invention;

FIG. 4 is a view showing the construction of a remote controller in accordance with the embodiment of the present invention;

FIGS. SA to 5C are flowcharts showing processes of downloading required data to a remote controller using a client PC; and

FIG. 6 is a flowchart showing a process of directly downloading required data to a remote controller.

### BEST MODE FOR CARRYING OUT THE INVENTION

An embodiment of the present invention will be described in detail with reference to the attached drawings below.

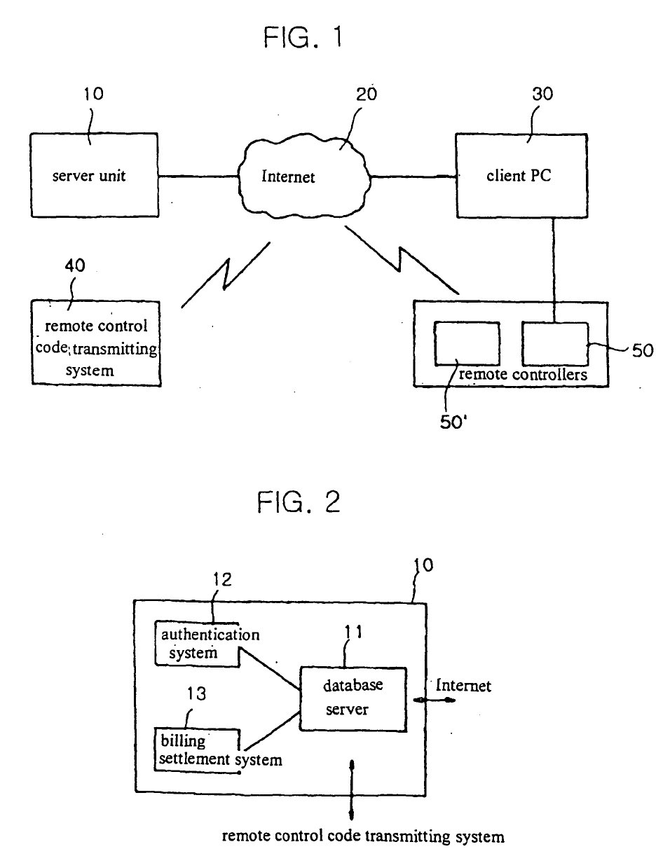

FIG. 1 is a view schematically showing the construction of a system for downing remote control data using the Internet in accordance with the embodiment of the present invention. FIG. 2 is a view showing the construction of a server unit in accordance with the embodiment of the present invention.

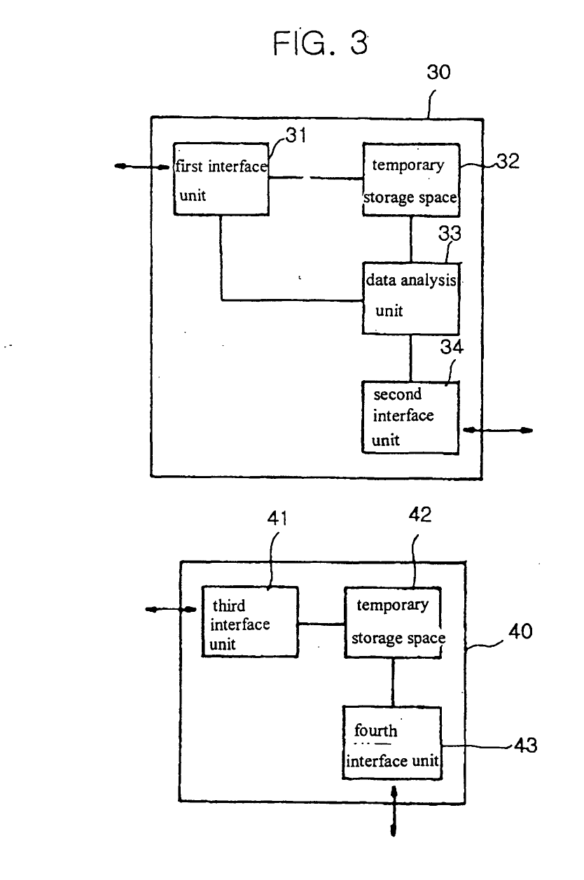

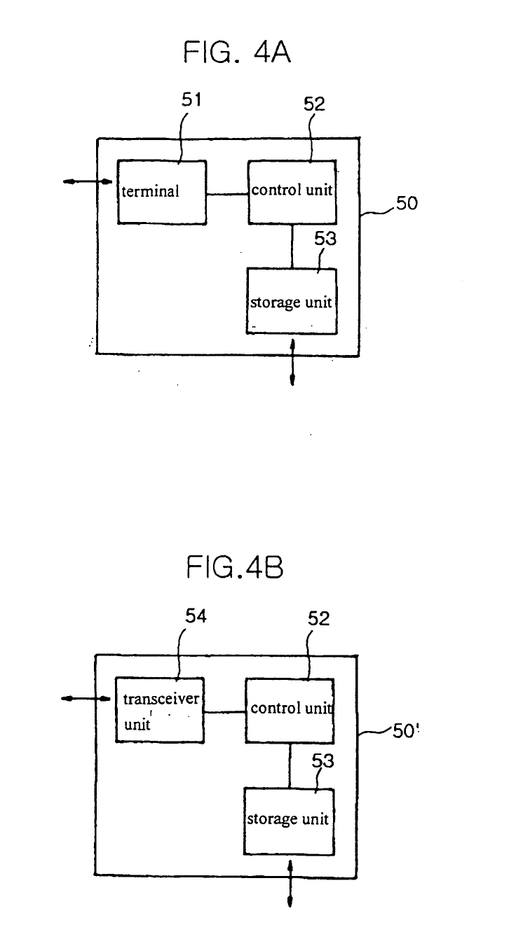

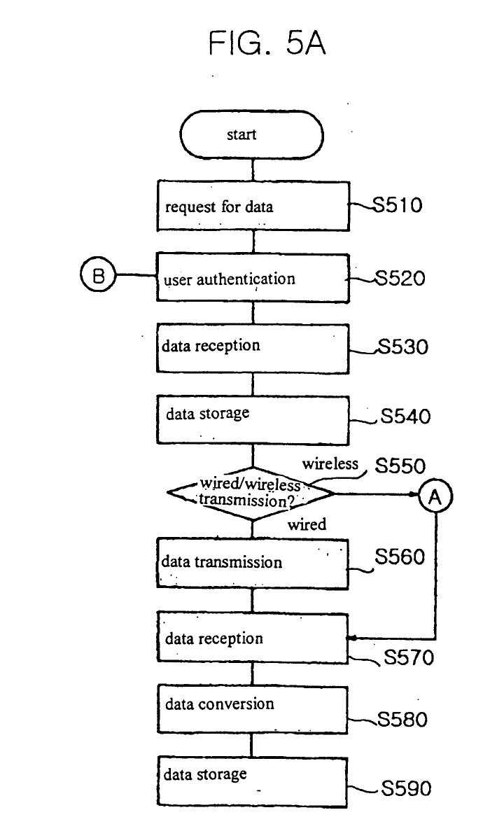

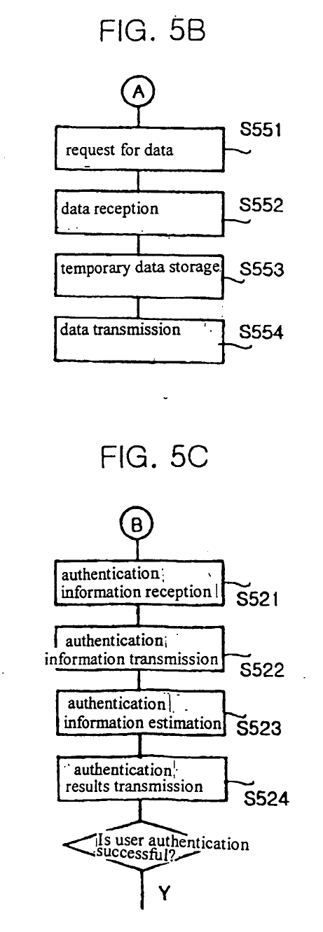

FIG. 3 is a view showing the construction of a remote control data processing unit in accordance with the embodiment of the present invention. FIG. 4 is a view showing the construction of a remote controller in accordance with the embodiment of the present invention.

Referring to FIG. 1, the system for downloading remote control data using the Internet in accordance with the embodiment of the present invention includes a server unit 10 that has remote control data and performs user authentication, billing, etc., an Internet 20 that connects the server unit 10 to a client Personal Computer (PC), a client PC 30 that is wirelessly connected to remote controllers, communicates with the server unit 10 via the Internet 20, and allows the selection of required remote control data and the downloading of the data to a remote controller, a remote control code transmitting system 40 that receives remote control data selected by a user from the server unit 10 and wirelessly transmits the data to the remote controller 50&APOS;, and a remote controller 50 or 50′ that can download the remote control data selected by the user through the client PC 30 in a wired manner or the remote control code transmitting system 40 in a wired manner and set the data therein.

The remote controller 50′that can download the remote control data in a wireless manner includes a mobile communications terminal with a remote controller function. The mobile communications terminal is a general term for devices having a mobile communications function, such as a general mobile phone, Personal Digital Assistant, etc.

The remote controller 50′ that can download the remote control data in a wired manner may include the function of the client PC 30. In this case, the user accesses the server unit 10 via the wireless Internet, selects desired data and downloads the desired data through the remote control code transmitting system 40 through the manipulation of the remote controller 50′.

Accordingly, when the user of the remote controller 50 or 50′ selects data required for an apparatus to be operated from data stored in the server unit 10, the selected data is downloaded to the remote controller 50 or 50′ through the client PC 30 or remote control code transmitting system 40 in a wired/wireless manner and set in the remote controller 50 or 50′, so the user can utilize the remote controller 50 or 50′ as a remote controller for the apparatus to be operated.

FIG. 2 is a view showing the construction of the server unit 10 that includes a database server 11, an authentication system 12 and a billing settlement system 13.

Referring to FIG. 2, the database server 11 has remote control data for various apparatuses using remote controllers, such as televisions, videocassette players, audio systems, air conditioners, etc., and performs response and data transmission with respect to transmitted various requests through the client PC 30 or wireless remote controller 50′.

The authentication system 12 is connected to the database server 11, and performs user authentication to allow only authenticated users to download data and transmits authentication results to the database server 11.

The billing settlement system 13 serves to receive billing information from the database server 11, and update the billing information of users.

Depending upon an embodiment of the present invention, the authentication system 12 and the billing settlement system 13 may not be employed.

FIG. 3 is a view showing the construction of a remote control data processing unit included in the client PC 30 and the remote control code transmitting system 40. Referring to FIG. 3, the remote control data processing unit includes a first interface unit 31 that transmits a request for the downloading of desired data and user information to the server unit 10 through the Internet 10 through the manipulation of the user and receives data in response to the data transmission, a temporary storage space 32 that temporarily stores the data, a data analysis unit 33 that analyzes the data stored in the temporary storage space 32 and determines whether the data is transmitted to the remote controller 50 in a wired manner or to the remote controller 50′ in a wireless manner, and a second interface unit 34 that transmits the data if it is determined that the data is transmitted to the remote controller 50 in a wired manner, wherein the data analysis unit 33 requests the server unit 10 to transmit the remote control data to the remote control code transmitting system 40 through the first interface unit 31 if the it is determined that the data is transmitted to the remote controller 50′ in a wireless manner. The remote control data processing unit further includes a third interface unit 41 that is included in the remote control transmission system 40 and receives data transmitted from the server unit 10, a temporary storage space 42 that temporarily stores the data, and a fourth interface unit 43 that transmits the stored data to the remote controller 50′.

In accordance with another embodiment of the present invention, the remote controller 50′ may includes the first interface unit 31 and the temporary storage space 32. In this case, the remote controller 50′ may receive remote control data that are selected through the communications of the fourth interface unit 43 with the first interface unit 31.

In the above-described case, the first interface 31 includes a Web browser that is daily used on the Internet and a Wireless Application Protocol (WAP) browser that is used in mobile communications terminals. A line that connects the remote controller 50 with the client PC 30 includes a Universal Serial Bus (USB).

FIGS. 4A and 4B are both views showing the construction of the remote controller that can be used in the above-described system for downloading remote control data. Referring to FIG. 4A, the remote controller 50 includes a terminal 51 that allows the remote controller 50 to be connected to the client PC 30 through a line, a control unit 52 that analyzes the transmitted data and converts the data into data in a required manner, and a storage unit 53 that is connected to the control unit 52 to store the converted data, along with elements contained in a conventional remote controller, including a key input unit that generates a control signal according to the selection of the user, a Central Processing Unit (CPU) that includes an infrared code generating means for receiving the control signal and generating a predetermined infrared ray code and controls the entire system, and an infrared ray signal generating unit that receives the infrared ray code from the CPU and inputs an infrared ray signal corresponding to the infrared ray code.

Referring to FIG. 4B, the remote controller 50′ in accordance with another embodiment of the present invention includes a transceiver unit 51 that can wirelessly transmit and receive required data to and from the server unit 10 and the remote control code transmitting system 40, a control unit 52 that converts received remote control data into data in a required manner, and a storage unit 53 that stores the converted data. In the case where the remote controller 50′ is a mobile communications terminal having a remote control function, a conventional mobile communication terminal module is added to the remote controller 50′, along with elements contained in a conventional remote controller, including a key input unit that generates a control signal according to the selection of the user, a CPU that includes an infrared code generating means for receiving the control signal and generating a predetermined infrared ray code and controls the entire system, and an infrared ray signal generating unit that receives the infrared ray code from the CPU and inputs an infrared ray signal corresponding to the infrared ray code.

Accordingly, the user of the remote controller of the present invention can easily download required remote control data using the system of the present invention and use it. Methods of downloading remote control data are different depending upon where the remote control data is downloaded to the remote controller in a wired or wireless manner. The processes of the two different methods are shown in FIGS. 5A and SB, respectively.

FIG. 5A is a flowchart showing a process of downloading selected data to the remote controller 50 connected to the client PC 30 in a wired manner. This process is described with reference to FIG. SA below.

The client PC 30 accesses the server unit 10 through the first interface unit 31 and requests remote control data selected by the user from the server unit 31 at step S510, undergoes user authentication in the server unit 10 at step S520, receives data transmitted in response to the request through the first interface unit 31 at step S530, and stores the data in the temporary storage space 32 at step S540. Thereafter, the client PC 30 determines whether the data should be transmitted to the remote controller 50 or 50′ in a wired or wireless manner by analyzing the remote control data stored in the temporary storage space 32 through the use of the data analysis unit 33 at step S550. The case where the remote control data is transmitted to the remote controller 50′ in a wireless manner is described in detail in FIG. 5B. In the case where the remote control data is transmitted to the remote controller 50 in a wired manner, the data is transmitted through the second interface unit 34 connected to the remote controller 50 in a wired manner at step S560. The remote controller 50 receives the transmitted data through the terminal 51 at step S570, and thereafter analyzes the received data and converts the received data into data in a required manner at step S580. Subsequently, the remote controller 50 stores the converted data in the storage unit 53 at step S590.

FIG. 5B is a flowchart showing a process of downloading selected data to the remote controller 50′ in a wireless manner. This process is described with reference to FIG. 5B below. In the case where the remote control data is transmitted to the remote controller 50 &APOS;IN a wireless manner, the server unit 10 is requested to transmit the remote control data to the remote control code transmitting system 40 through the first interface unit 31 at step S551. The remote control code transmitting system 40 receives transmitted data through the third interface unit 41 at step S552 and temporarily stores the data in the temporary storage space at step S553. Thereafter, the remote control code transmitting system 40 wirelessly transmits the data stored in the temporary storage space 42 through the fourth interface unit 43 to the remote controller 50′ at step S554. Steps after step S554 are identical with steps S570 to S590.

FIG. 5C is a flowchart showing the user authentication step (step S520) in the server unit 10 in detail. Referring to FIG. 5C, the database server 11 receives authentication information from the client PC 30 at step S521, and transmits the received authentication information to the authentication system 12 at step S522. The authentication system 12 analyzes the authentication information at step S523, and transmits analysis results to the database server 11 at step S524. The database server 11 determines whether user authentication is successful based on the received analysis results at step S525, and the process proceeds to the next step if the user authentication is successful.

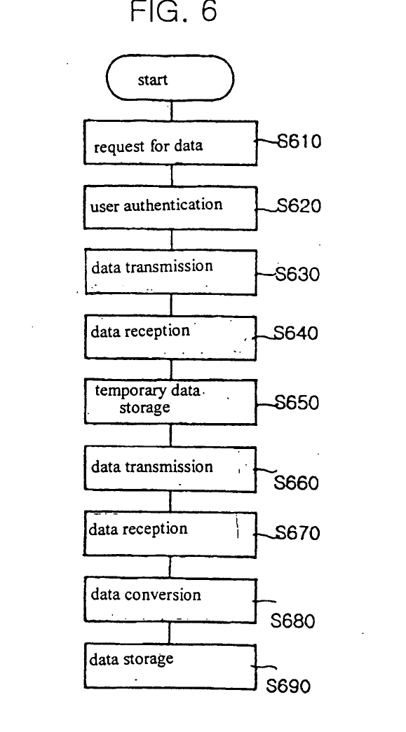

FIG. 6 is a flowchart showing a process of directly downloading control data using a mobile communications terminal having a remote controller function in accordance with another embodiment of the present invention. This process is described with reference to FIG. 6 below.

The remote controller 50′ accesses the server unit 10 through the first interface unit 31 and requests remote control data selected by the user from the server unit 31 at step S610, and the server unit 10 performs user authentication and transmits at step S620 and transmits remote control data to the remote control code transmitting system 40 at step S630. The remote control code transmitting system 40 receives the transmitted data through the third interface unit 41 at step S640, and stores the data in the temporary storage space 42 at step S650.

Thereafter, the remote control code transmitting system 40 wirelessly transmits the data stored in the temporary storage space 42 through the fourth interface unit 43 to the remote controller 50′ at step S660. The remote controller 50′ receives the transmitted data through the transceiver 54 at step S670, analyzes the data and converts the data in a required manner using the control unit 52 at step S680, and stores the converted data in the storage unit 53 at step S690.

In the above-described case, the remote controller 50′ having downloaded the data may be connected to the general remote controller 50 with a line and transmit the data to the general remote controller 50.

In accordance with the above-described processes, the user can easily download required remote control data to the remote controller and set the data in the remote controller.

As described above, in accordance with the present invention, required remote control data can be automatically downloaded to and set in the remote controller via the Internet without a complicated remote control setting process for the conventional integrated remote controller, so the remote controller of the present invention can be easily and conveniently used as a remote controller for an apparatus whose control is desired.

### INDUSTRIAL APPLICABILITY

The present invention can be applied to a system and method that is able to download remote control data for required apparatuses to a remote controller via the Internet so as to allow a single remote controller to be used for a variety of apparatuses.

1. A system for downloading remote control data using the Internet, comprising:
a server unit (10) having remote control data;
a client Personal Computer (PC) (30) processing the remote control data;
a remote control code transmitting system (40);
the Internet (20) connecting the server unit (10), the client PC (30) and the remote control code transmitting system (40) to each other; and
two remote controllers (50 and 50′) connected to the system in wired and wireless manners, respectively;
wherein the server unit (10) comprises
a database server (11) having the remote control data for apparatuses to be remotely controlled and performing responses and data transmission with respect to various requests,
an authentication system (12) connected to the database server (11) to perform user authentication, and
a billing settlement system (13) connected to the database server (11) to update billing information of users;
wherein the client PC (30) comprises
a first interface unit (31) requesting the server unit (10) to transmit the remote control data through the Internet 20 and receiving transmitted remote control data,
a temporary storage space (32) temporarily storing the received remote controller data,
a data analysis unit (33) determining a transmission method of the remote control data, and
a second interface unit (34) transmitting the remote control data in a wired manner;
wherein the remote control code transmitting system (40) comprises
a third interface unit (41) receiving transmitted remote control data through the first interface unit (31),
a temporary storage space (42) temporarily storing the received data, and
a fourth interface unit (43) transmitting the stored remote control data to the remote controller (50′) in a wireless manner;
wherein the remote controllers (50 and 50′) each comprise
a terminal (51) connected to the client PC (30) in a wired manner to receive the remote control data, or transceiver unit (54) receiving the remote control data from the remote control code transmitting system (40) in a wireless manner,
a control unit (52) converting the transmitted data into data in a required manner, and
a storage unit (53) storing the data converted by the control unit (52).

2. The system as set forth in claim 1, wherein the second interface unit (34) of the client PC (30) is connected to the terminal (51) of the remote controller (50) with a universal serial bus.

3. The system as set forth in claim 1, wherein the remote controller (50′) is a mobile communications terminal having a remote control function.

4. The system as set forth in claim 1, wherein the remote controller (50′) further comprises:
a first interface unit (31) requesting the server unit (10) to transmit remote control data and receiving transmitted remote control data; and
a temporary storage space (32) temporarily storing received remote control data.

5. A method for downloading remote control data using the Internet, comprising:
the 1st step of a client PC (30) requesting remote control data, which is selected by a user to download, from a server unit (10) through a first interface unit (31);
the 2nd step of the client PC (30) undergoing user authentication in the server unit (10);
the 3rd step of the client PC (30) receiving remote control data transmitted from the server unit (10) in response to the request through the first interface unit (31);
the 4th step of the client PC (30) temporarily storing the received remote control data in the temporary storage space (32);
the 5th step of the client PC (30) determining whether the remote control data is transmitted in a wired or wireless manner through the use of a data analysis unit (33);
the 6th step of the client PC (30) transmitting the remote control data to a terminal (51) of the remote controller (50) through a second interface unit (34) if it is determined that the data is transmitted in a wired manner;
the 7th step of the remote controller (50) receiving the remote control data from the terminal (51);
the 8th step of the remote controller (50) converting the remote control data into data in a required manner through a control unit (52); and
the 9th step of the remote controller (50) storing the converted remote control data in a storage unit (53).

6. The method set forth in claim 5, wherein the 6th and 7th steps are replaced by the following steps, if it is determined that the remote control data is transmitted in a wireless manner at the 5th step:
the 5-1ST step of the client PC (50) requesting the server unit (35) to transmit the remote control data to the remote control code transmitting system (40) through the first interface unit (31);
the 5-2nd step of the remote control code transmitting system (40) receiving the remote control data transmitted from the server unit (10) through the third interface unit (41);
the 5-3rd step of the remote control code transmitting system (40) storing the transmitted remote control data in the temporary storage space (42); and
the 6-1st step of the remote control code transmitting system (40) transmitting the stored remote control data to the transceiver (54) of the remote controller (50′) through the fourth interface unit (43) in a wireless manner.

7. The method set forth in claim 5, wherein the 2nd step further comprises:
the 2-1st step of a database server (11) receiving authentication information from the client PC (30);
the 2-2nd step of the database server (11) transmitting the authentication information to the authentication system (12);
the 2-3rd step of the authentication system (12) performing user authentication using the authentication information;
the 2-4th step of the authentication server (12) transmitting authentication results to the database server (11); and
the 2-5th step of the database server (11) determining whether user authentication is successful based on the transmitted authentication results.

8. A method for downloading remote control data via a mobile communication terminal having a remote control function, comprising:
the 1st step of a remote controller (50′) requesting remote control data, which is selected by a user to download, from a server unit (10) through a first interface unit (31);
the 2nd step of the remote controller (50′) undergoing user authentication in the server unit (10);
the 3rd step of the server unit (10) transmitting the selected remote control data to a remote control code transmitting system (40);
the 4th step of the remote control code transmitting system (40) receiving the transmitted remote control data through a third interface unit (41);
the 5th step of the remote control code transmitting system (40) temporarily storing the received remote control data in a temporary storage space (42);
the 6th step of the remote control code transmitting system (40) transmitting the remote control data to a transceiver unit (54) of the remote controller (50′) through a fourth interface unit (43) in a wireless manner;
the 7th step of the remote controller (50′) receiving the transmitted remote control data through the transceiver unit (54);
the 8th step of the remote controller (50′) converting the received remote control data into data in a required manner through a control unit (52); and
the 9th step of the remote controller (50′) storing the converted remote control data in a storage unit (53).

9. The system as set forth in claim 3, wherein the remote controller (50′) further comprises:
a first interface unit (31) requesting the server unit (10) to transmit remote control data and receiving transmitted remote control data; and
a temporary storage space (32) temporarily storing received remote control data.
